(19) United States
(12) Patent Application Publication
(10) Pub. No.: US 2026/0339408 A1
(43) Pub. Date: Oct. 29, 2026

(54) UTILIZING SYSTEM FIRMWARE INTERMEDIARY FOR RUNTIME PERIPHERAL COMPONENT INTERCONNECT EXPRESS POWER MANAGEMENT

(71) Applicant: DELL PRODUCTS L.P., Round Rock, TX (US)

(72) Inventors: Austin P. Bolen, Austin, TX (US); Timothy M. Lambert, Austin, TX (US)

(21) Appl. No.: 19/191,721

(22) Filed: Apr. 28, 2025

(51) Int. Cl. G06F 1/26

(52) U.S. Cl. CPC G06F 1/26

(57) ABSTRACT

An information handling system may receive a notification to power off a peripheral component interconnect express (PCIe) device of the information handling system. Subsequent to the receipt of the notification, the information handling system may simulate a hot removal of the PCIe device by utilizing a system firmware intermediary feature of a PCIe port above the PCIe device. The information handling system may then turn off power provided to the PCIe device. In response to receiving a notification that the PCIe device will be utilized to run a workload, provide power to the PCIe device, and then configure the PCIe device. Further, the information handling system may simulate a hot insertion of the PCIe device prior to running the workload using the PCIe device.

### FIELD OF THE DISCLOSURE

The present disclosure generally relates to information handling systems, and more particularly relates to utilizing a system firmware intermediary for runtime peripheral component interconnect express power management.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may receive a notification to power off a peripheral component interconnect express (PCIe) device of the information handling system. Subsequent to the receipt of the notification, the information handling system may simulate a hot removal of the PCIe device by utilizing a system firmware intermediary feature of a PCIe port above the PCIe device. The information handling system may then turn off power provided to the PCIe device. In response to receiving a notification that the PCIe device will be utilized to run a workload, provide power to the PCIe device and configure the PCIe device. Further, the information handling system may simulate a hot insertion of the PCIe device prior to running the workload using the PCIe device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment for utilizing a system firmware intermediary (SFI) for runtime peripheral component interconnect express (PCIe) power management, according to at least one embodiment of the present disclosure;

FIGS. 2 and 3 are block diagrams of systems for utilizing an SFI for runtime PCIe power management, according to at least one embodiment of the present disclosure;

FIGS. 4 and 5 are flowcharts of methods for utilizing an SFI for runtime PCIe power management, according to at least one embodiment of the present disclosure; and

FIG. 6 is a block diagram of a general information handling system according to at least one embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Many information handling systems, such as gaming devices and other graphics-intensive computing devices as well as devices utilized to perform artificial intelligence (AI) tasks, include discrete graphics processing units (GPUs), also referred to as accelerator add-in cards (AICs), that are separate from central processing units (CPUs) of an information handling system. These information handling systems typically include multiple GPUs, which are designed to support AI workloads, machine learning (ML) workloads, high-performance computing (HPC) workloads, etc. It has been found that currently, these GPUs along with other peripheral component interconnect express (PCIe) devices have significant power consumption, even when idle, which increases a user's total cost of ownership. For example, some GPUs consume approximately 75 to 180 watts when idle.

Some information handling systems are designed to support a substantial number of PCIe slots, such as 16 GPU slots and 8 general-purpose card electromechanical (CEM) slots, which can result in power management challenges. In addition, hardware throttling via a power brake function (PWRBRK #) as provided in the PCIe specification typically applies to all the PCIe slots instead of individual or selectable PCIe slots. Accordingly, because of the need to remove power to specific PCIe devices when not in use, the aforementioned functions to control the power of all the PCIe devices are not suitable in this situation. An information handling system may be improved by dynamically saving idle power, such as when the information handling system is not executing a workload. The ability to dynamically save the idle power may be performed without powering down the information handling system is desirable, as time to readiness for a new workload would be adversely affected by such a power down. Thus, users benefit from initial fast power reduction and the ability to resume a workload quickly.

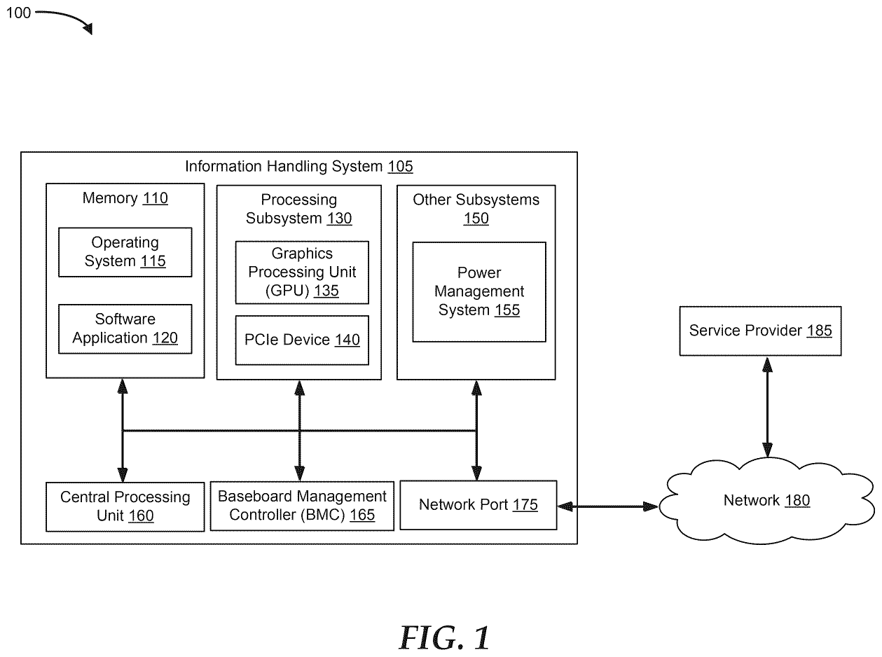

FIG. 1 illustrates a portion of an environment 100 for utilizing system firmware intermediary (SFI) for runtime PCIe power management, according to an embodiment of the present disclosure. In particular, environment 100 may be configured to control power to one or more PCIe devices of an information handling system. Environment 100 includes an information handling system 105, a network 180, and a service provider 185. Information handling system 105 includes a memory 110, a processing subsystem 130, other subsystems 150, a CPU 160, a baseboard management controller (BMC) 165, and a network port 175. Service provider 185 is accessible by information handling system 105 via network 180 through network port 175. Memory 110 includes an operating system 115 and a software application 120. Processing subsystem 130 includes a GPU 135 and another PCIe device 140. Other subsystems 150 include a power management system 155. In one embodiment, memory 110, processing subsystem 130, CPU 160, BMC 165, and network port 175 may be interconnected via one or more buses. However, any variety of connections between the various components is envisioned as falling within the scope of the present disclosure. In addition, connections between components may be omitted for descriptive clarity.

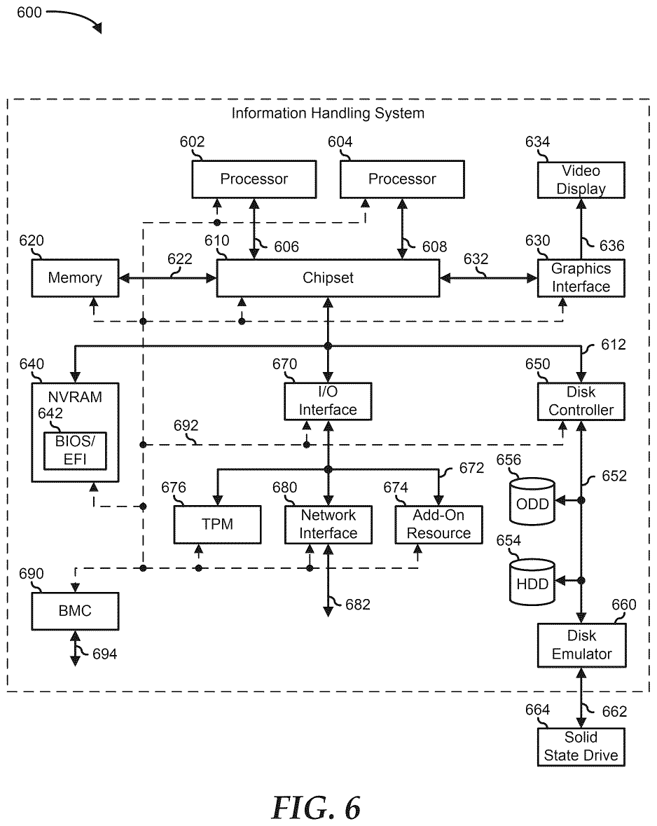

Information handling system 105, which is similar to information handling system 600 of FIG. 6, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. In one embodiment, information handling system 105 may be a server and one of multiple information handling systems within a data center. For example, information handling system 105 may be a blade server that is physically configured to be mounted within a server rack. Information handling system 105 may also be a portable information handling system that may include a laptop, a notebook, a smartphone, a tablet, or a personal digital assistant, among others.

Memory 110, which is similar to memory 620 of FIG. 6, may be communicatively coupled to CPU 160 and may include any system, device, or apparatus operable to retain program instructions or data, wherein the instructions may be executed by processing subsystem 130 and/or CPU 160. Memory 110 may include a random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to information handling system 105 is turned off. Memory 110 may include a static SRAM, a dynamic random access memory (DRAM), or any suitable device to support high-speed memory operations. In certain embodiments, memory 110 may combine both persistent, non-volatile memory and volatile memory. In certain embodiments, memory 110 may include multiple removable memory modules.

Operating system 115 such as Microsoft Windows NT™, Microsoft Windows 2000™, or IBM OS/2™ may be configured to manage hardware and software resources of information handling system 105. Software application 120 may be a computer program for use by an end-user and/or a workload, such as an AI workload, ML workload, or similar. In one embodiment, software application 120 may be associated with one or more PCIe hardware devices, such as GPU 135 and PCIe device 140. For example, GPU 135 may be utilized to execute software application 120.

Processing subsystem 130 includes one or more processors that are discrete from CPU 160, such as GPU 135 and PCIe device 140. In certain embodiments, processing subsystem 130 may be configured to support AI workloads, ML workloads, HPC workloads, etc. In another embodiment, processing subsystem 130 can include different processors and/or additional processors than shown. For example, processing subsystem 130 may include a neural processing unit (NPU) and/or an AI processor configured to process the AI workloads. The NPU may be of various types. For example, the NPU may be a discrete NPU or an integrated NPU. In yet another embodiment, processing subsystem 130 may include only one of GPU 135 or PCIe device 140. GPU 135, which may be similar to a graphics adapter 630 of FIG. 6, may comprise any system, device, or apparatus configured to process graphical or visual content and to communicate that content to a monitor or display where the content may be rendered.

PCIe device 140 may be an add-in card, such as a compute express link (CXL) device that is plugged into a PCIe slot, such as one of PCIe devices 260, 265, and 140. The PCIe slot may be connected to a PCIe port. PCIe device 140 can also be soldered down to a board of the information handling system 105. PCIe device 140 may also be one of various components included in processing subsystem 130 of FIG. 1, such as GPU 135 and PCIe device 140 of FIG. 1. Examples of PCIe device 140 include a graphics card, sound card, network interface card (NIC), wireless card, USB expansion card, storage controller card, thunderbolt card, non-volatile memory express (NVMe) drive, graphics accelerator, serial advanced technology attachment (SATA) drive, etc. PCIe device may also be one of several form factors, such as a CEM form factor.

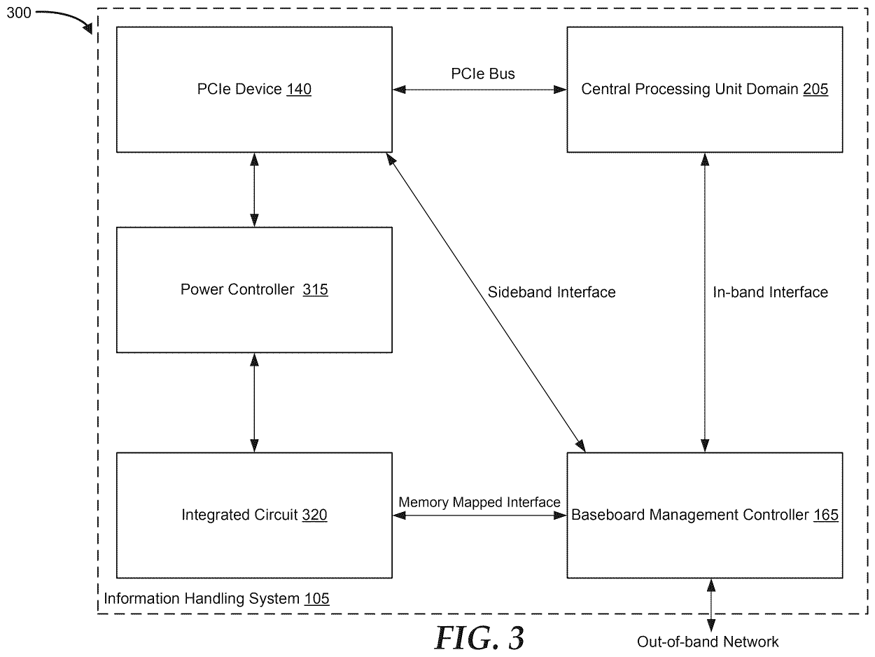

Other subsystems 150 may include one or more power supplies for supplying power to components of information handling system 105. Power management system 155 may include any system, device, or apparatus configured to perform an operation that manages and/or controls one or more aspects of a component slot, a supplementary source power connection, or a combination thereof. For example, power management system 155 may be configured to manage or control a power mode of an operation, a slot discovery operation, a virtual hot plug operation, a virtual slot physical presence detection operation, a supplementary source discovery operation, or a combination thereof. In particular, power management system 155 may be configured to manage and/or control power to GPU 135, PCIe device 140, and other peripheral devices or components associated with information handling system 105. For example, other subsystems 150 may include a power controller 315 and an integrated circuit 320 of FIG. 3.

CPU 160, which is similar to processors 602 and 604 of FIG. 6, may include any system, device, or apparatus operable to interpret and/or execute program instructions and/or process data, and may include, without limitation, a microprocessor, microcontroller, digital signal processor (DSP), application specific integrated circuit (ASIC), or any other digital or analog circuitry. For example, CPU 160 may be operable to perform operations associated with the execution of operating system 115 and software application 120 in memory 110.

BMC 165, which is similar to BMC 690 of FIG. 6, may be any system, device, or apparatus configured to facilitate management and/or control of information handling system 105 and/or one or more of its components. For example. BMC 165 may be configured to issue commands and/or other signals to power management system 155 to manage or control power provided to one or more PCIe devices. In one embodiment, BMC 165 may include a microprocessor, microcontroller, DSP, ASIC, field programmable gate array (FPGA), electrically erasable programmable read-only memory (EEPROM), or any combination thereof. In some embodiments, BMC 165 may be configured to communicate with memory 110, processing subsystem 130, other subsystems 150, CPU 160, network port 175, and/or other components of information handling system 105.

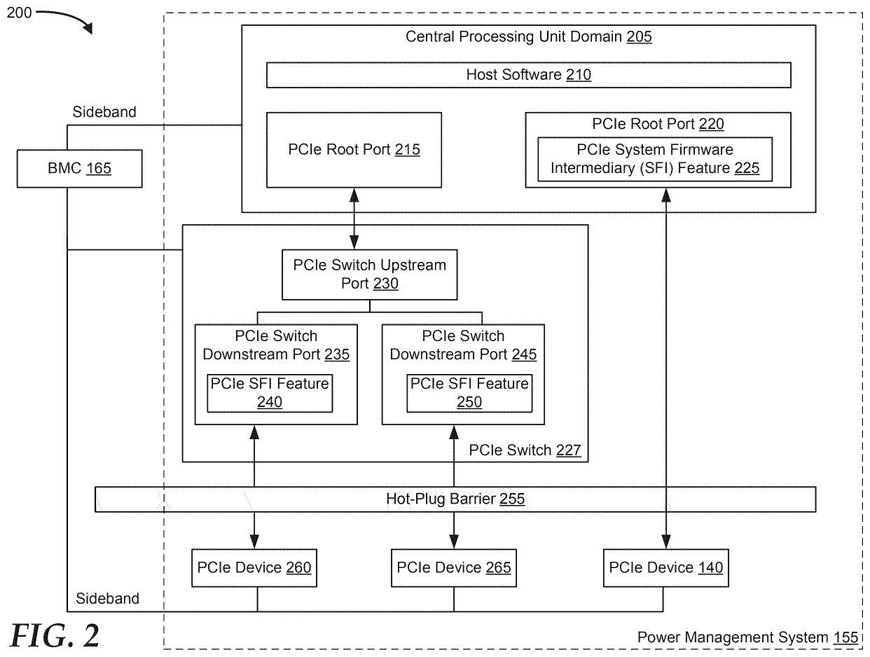

In certain embodiments, BMC 165 may be configured to control a physical presence indication of a PCIe device, such as GPU 135 and PCIe device 140. The physical presence indication may be provided to a root complex, such as a CPU domain 205 of FIG. 2, or a downstream-facing PCIe switch port. For example, a mask signal can update a value of the physical presence indicator from “1” to “0” while an unmask signal can update the value of the physical presence indicator from “0” to “1”. Updating the physical presence indicator may generate and transmit an interrupt to the operating system, notifying the operating system that the PCIe device was removed or inserted, respectively. In addition, BMC 165 may be configured to control a link active state, readiness notification, and access to the PCIe device. Subsequently, each one of GPU 135 and PCIe device 140 may be independently powered up or powered down, such as via a discrete logic circuit like the FPGA and power controller 315. Although BMC 165 is depicted to act as an intermediary between operating system 115 or host software and the PCIe device using the SFI feature of a PCIe port above the PCIe device, one of ordinary skill in the art will appreciate that other system firmware may be configured as the intermediary, such as Unified Extensible Firmware Interface (UEFI)/BIOS, or similar.

Network port 175 may be any system, device, or apparatus such as a switch or router port that is configured to provide in-band and out-of-band traffic between information handling system 105 and service provider 185 via network 180. Network 180 may be implemented as or maybe a part of, a storage area network (SAN), a personal area network (PAN), a local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data and/or messages.

Network 180 may transmit data using any storage and/or communication protocol, including without limitation, Fibre Channel, Frame Relay, Asynchronous Transfer Mode (ATM), Internet Protocol (IP), other packet-based protocol, small computer system interface (SCSI), Internet SCSI (iSCSI), Serial Attached SCSI (SAS), or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 180 and its various components may be implemented using hardware, software, or any combination thereof. These components may be configured to facilitate communication between information handling system 105 and service provider 185. Service provider 185 may include one or more application programming interfaces for receiving communications from information handling system 105 via network 180.

Service provider 185 may be hosted on a server, mainframe, workstation, network computer, desktop, or the like. In one embodiment, service provider 185 may be configured as a workload scheduler that assigns workloads to one or more information handling systems in environment 100, such as information handling system 105. In particular, the workload scheduler may assign the workload to a specific processor or PCIe device based on various factors. In addition, service provider 185 may be configured to notify BMC 165 prior to assigning a workload to a particular processor or PCIe device. Service provider 185 may also notify BMC 165 when it revokes the assignment.

FIG. 2 illustrates a portion of a system 200 for utilizing SFI for runtime PCIe power management, according to an embodiment of the present disclosure. In particular, system 200 may be configured to control power to one or more PCIe devices of an information handling system. System 200 includes BMC 165 and power management system 155. Power management system 155 includes CPU domain 205, a PCIe switch 227, a hot-plug barrier 255, a PCIe device 260, a PCIe device 265, and PCIe device 140. Power management system 155 may also include GPU 135. CPU domain 205 may be communicatively coupled with PCIe switch 227, and PCIe devices 260, 265, and 140. PCIe switch 227 may be communicatively coupled with PCIe devices 260 and 265. However, any variety of connections between CPU domain 205, PCIe switch 227, and PCIe devices 260, 265, and 140 are envisioned as falling within the scope of the present disclosure. In addition, connections between components may be omitted for descriptive clarity.

CPU domain 205 may be any system that includes various hardware and software resources associated with utilization of PCIe device 140, such as resources included in power management system 155 of FIG. 1 and CPU 160 of FIG. 1. CPU domain 205 includes a host software 210, a PCIe root port 215, and a PCIe root port 220 which includes a PCIe SFI feature 225. A PCIe root complex may also be integrated into CPU domain 205. However, in some embodiments, the PCIe root complex may be discrete from CPU domain 205. In addition, CPU domain 205 may include a PCIe switch. CPU domain 205 may be any system, device, or apparatus that can include one or more root ports and other computing resources, such as one or more processor cores and a cache. The root port may be used to communicate with one or more peripheral devices below it, such as PCIe devices 260, 265, and 140. For example, CPU domain 205 may be an ASIC or a package associated with a CPU, such as CPU 160. CPU domain 205 may facilitate communication between host software 210 and the PCIe devices via the root ports. Host software 210 includes an operating system and one or more software and/or firmware installed locally, such as a driver, software application, UEFI/BIOS, operating system, etc.

A peripheral root port, such as PCIe root ports 215 and 220, can be a physical peripheral interface that allows for an operative connection of a peripheral device or peripheral switch. A peripheral root port may provide a common interface, such as size pin layout, etc. and the PCIe protocol. This allows a peripheral device, such as PCIe devices to communicate with the PCIe root complex and other computing resources, such as host software 210. PCIe root port 215 may be any system, device, or apparatus that is configured to facilitate communication between PCIe devices associated with PCIe switch 227 and CPU domain 205, such as PCIe devices 260 and 265. PCIe root port 220, which is similar to PCIe root port 215, may be configured to facilitate communication between PCIe device 140 and CPU domain 205.

PCIe SFI features 225, 240, and 250 may represent an interface that may be defined in a particular standard, such as a PCIe standard, wherein the PCIe SFI features may provide controls that an intermediary, such as BMC 165, may use to isolate, such as to hide or expose PCIe devices from the operating system and/or host software 210. In one example, PCIe SFI feature 225 may be configured to isolate PCIe device 140 while PCIe SFI features 240 and 250 may be configured to isolate PCIe devices 260 and 265, respectively. In particular, PCIe SFI feature 225 may isolate PCIe device 140 associated with PCIe root port 220 from host software 210 and/or processing subsystem. Accordingly, PCIe SFI feature 240 may isolate PCIe device 260 associated with PCIe root port 215 and PCIe switch downstream port 235 from host software 210 and/or the processing subsystem. In addition, PCIe SFI feature 250 may isolate PCIe device 265 associated with PCIe root port 215 and PCIe switch downstream port 245 from host software 210 and/or the processing subsystem.

The isolation of the PCIe devices may be performed in a PCIe root port and PCIe switch downstream port utilizing native operating system PCIe hot-plug infrastructure. The PCIe hot-plug infrastructure provides options to invoke a system firmware, such as UEFI/BIOS, BMC, etc. for hot-plug events or interrupts. The hot-plug interrupts generated by a PCIe root port or PCIe switch downstream port may be blocked from being delivered to host software 210 so that platform-specific actions can be performed. The PCIe SFI feature of the PCIe port may be configured to intercept PCIe hot-plug events to perform platform-specific actions by adding a firmware layer between the host software and PCIe devices to enhance robustness, security, and traceability of hot-plug events without impacting data path when the PCIe devices are exposed to the operating system and/or host software. In a BIOS context, “hot plug” refers to the ability to add or remove a PCIe device while the computer is running, without needing to restart or shut down the system. Hot plugging allows a user to connect or disconnect the PCIe device to or from an information handling system while the information handling system is powered on and operating.

PCIe switch 227 may be any system, device, or apparatus with a switching mechanism for directing data packets from or to a PCIe device and CPU domain 205. PCIe switch 227 includes a PCIe switch upstream port 230, a PCIe switch downstream port 235, and a PCIe switch downstream port 245. PCIe switch upstream port 230 may be configured as a conduit between PCIe root port 215 and PCIe switch downstream ports 235 and 245. PCIe switch downstream ports 235 and 245 may be configured to interface with PCIe devices 260 and 265, respectively. PCIe switch downstream port 235 includes a PCIe SFI feature 240. PCIe switch downstream port 245 includes a PCIe SFI feature 250. PCIe SFI feature 225, PCIe SFI feature 240, and PCIe SFI feature 250 may be configured to add a system firmware layer between host software 210 and PCIe devices 260, 265, and 140 for the hot-plug functionality. In particular, the PCIe SFI feature may be configured to intercept, modify, filter, forward, and/or otherwise alter data emanating from (or destined to) a peripheral device, such as a PCIe device.

Hot-plug barrier 255 may be any system, device, or apparatus that is configured to allow PCIe devices, CXL devices, or similar bound below hot-plug barrier 255 to be hot-pluggable while PCIe devices, CXL devices, or similar devices that are bound above hot-plug barrier 255 to not be hot-pluggable. Although hot-plug barrier 255 is shown to be configured below PCIe switch 227, one of ordinary skill in the art will appreciate that hot-plug barrier 255 may be configured above PCIe switch 227, such that hot-plug barrier 255 may be between PCIe switch 227 and CPU domain 205. Accordingly, a PCIe SFI feature may be included above PCIe switch 227, such as PCIe SFI feature 225.

PCIe devices 260, 265, and 140 may be PCIe-compatible devices that include CXL-compatible devices, which can be video cards, sound cards, network interface cards, hardware redundant array of independent disks (RAID) controllers, solid state drivers, GPUs, etc. In addition, PCIe devices 260, 265, and 140 may be one of different form factors and connector sizes, such as CEM, PCIe M.2, and U.2 devices, among others. PCIe device 260 may be communicatively coupled to PCIe switch downstream port 235 via a PCIe bus. PCIe device 265 may be communicatively coupled to PCIe switch downstream port 245 via a PCIe bus.

Information handling systems, such as servers, desktop computers, and mobile personal computers include PCIe interfaces and ports for connecting and communicating with PCIe-compatible devices, such as PCIe devices 260, 265, and 140. In one example, PCIe devices 260, 265, and 140 may be physically coupled to a PCIe slot of information handling system 105 of FIG. 1.

BMC 165, which is similar to BMC 690 of FIG. 6, may be communicatively coupled to CPU domain 205, PCIe switch 227, and PCIe devices 260, 265, and 140 via a sideband connection. BMC 165 may be configured to hide one or more PCIe devices, such as PCIe devices 260, 265, and 140 using the PCIe SFI feature of the PCIe port via the sideband connection. To hide the PCIe devices, BMC 165 may use the PCIe SFI feature of the PCIe port to simulate a hot removal and block access to the PCIe devices, wherein the hot removal can be a “surprise removal” or a “prepared removal” of the PCIe device. If a PCIe device does not support the surprise removal feature, then a “prepare to remove” operation from within operating system 115 and/or a driver of the PCIe device may be performed prior to the BMC simulating a hot removal of the PCIe device. When the PCIe devices are hidden from the operating system, then BMC 165 can remove the main power to the PCIe devices. These processes may be performed while information handling system 105 remains operational and may not require power management functionality in the PCIe devices.

BMC 165 may use one or a combination of PCIe SFI feature 225, PCIe SFI feature 240, and/or PCIe SFI feature 250 to hide PCIe devices from host software 210. In one particular example, BMC 165 may utilize PCIe SFI feature 240 to hide PCIe device 260 from host software 210. In another particular example, BMC 165 may utilize PCIe SFI feature 250 to hide PCIe device 265 from host software 210. In yet another particular example, BMC 165 may utilize PCIe SFI feature 225 to hide PCIe device 140 from host software 210. Those of ordinary skill in the art will appreciate that the number and configuration of the PCIe devices in FIG. 2 may vary. For example, there may be more or less than the ones depicted herein.

FIG. 3 illustrates a portion of a system 300 of an information handling system 105 configured for SFI for runtime PCIe power management, according to an embodiment of the present disclosure. In particular, system 300 may be configured to control power to one or more PCIe devices of information handling system 105. Information handling system 105 includes a PCIe device 140, a CPU domain 205, power controller 315, integrated circuit 320, and a BMC 165. PCIe device 140 may be coupled with CPU domain 205 via a PCIe bus and BMC 165 via a sideband interface. In addition, PCIe device 140 may be communicatively coupled with power controller 315 which is communicatively coupled with integrated circuit 320. CPU domain 205 may be coupled with BMC 165 via an in-band interface. In addition, BMC 165 may be coupled with integrated circuit 320 via a memory-mapped interface. Further, BMC 165 may be coupled to a remote console via an out-of-band (OOB) network, which can be used by an administrator to manage and/or control information handling system 105. For example, the administrator or a user may schedule a workload via the OOB network.

Power controller 315 may be any system, device, or apparatus that is configured to manage and/or control PCIe device 140 via one or more signals. For example, power controller 315 may be part of power management system 155 of FIG. 1. Power controller 315 may represent a control logic that can be instantiated as discrete logic, programmable logic, microcontroller firmware, or the like. In particular, power controller 315 may be a serial peripheral interface (SPI) microcontroller or similar that is configured to control current flow to PCIe device 140 via one or more field-effect transistors. Power controller 315 may also generate a clock signal which may be used to synchronize data transmission to and from PCIe device 140. In addition, power controller 315 may also generate an auxiliary signal that indicates whether power provided by a power supply for PCIe device 140 is within a specified tolerance or threshold. Further, power controller 315 may be configured to assert a reset of a PCIe port. One of ordinary skill in the art will appreciate that power controller 315 may perform various functions other than explicitly provided herein.

Power controller 315 may be configured to control other PCIe devices in addition to PCIe device 140. For example, when a workload scheduler wants to run a workload in information handling system 105, the workload scheduler may notify BMC 165 that the workload is about to be executed on a PCIe device and/or transmit a command to BMC 165 to power on the PCIe device and then simulate a hot-insertion of the PCIe device. In another example, when the workload scheduler knows that it will not run a workload on a PCIe device for a specified time, wherein the specified time exceeds a threshold, the workload scheduler may notify BMC 165 that no workload is to be executed on the PCIe device for the specified time and/or transmit a command to BMC 165 to simulate a hot removal of the PCIe device and then power off the PCIe device.

Integrated circuit 320 may be configured to manage or control one or more signals that may be generated by power controller 315 based on one or more instructions or commands from BMC 165. For example, integrated circuit 320 may be configured to control power and clock/reset signals on a PCIe bus between a PCIe device, PCIe root port, and/or PCIe switch downstream port. Integrated circuit 320 may direct power controller 315 to apply or remove power from PCIe device 140 based on instructions received from BMC 165. In one embodiment, integrated circuit 320 may be an FPGA, a microprocessor, or similar.

BMC 165 may be configured to manage and control power provided to PCIe device 140, such as to apply or remove power from PCIe device 140 while its host computer is operational. For example, BMC 165 may utilize SFI to mask or unmask PCIe device 140 from CPU domain 205 instead of utilizing one or more runtime power methods, such as setting a power limit to PCIe device 140 via the UEFI/BIOS or by using a power brake function. The determination by BMC 165 on whether to mask or unmask PCIe device 140 may be triggered by one or more inputs, such as a notification or request from a workload scheduler, user, etc.

When PCIe device 140 is masked or hidden from CPU domain 205, then BMC 165 may direct integrated circuit 320 to remove power provided to PCIe device 140 via power controller 315, wherein power controller 315 may generate one or more signals accordingly. In another example, when PCIe device 140 is unmasked or exposed to CPU domain 205, then BMC 165 may direct integrated circuit 320 to provide power to PCIe device 140 via power controller 315, wherein power controller 315 may generate one or more signals accordingly. This process may replace other throttling controls, such as power brake, thermal control circuit activation, etc., which typically controls power to the information handling system and not a specific PCIe device.

Those of ordinary skill in the art will appreciate the configuration, hardware, and/or software components of environment 100 depicted in FIG. 1, system 200 in FIG. 2, and system 300 of FIG. 3 may vary. For example, the illustrative components within environment 100, system 200 of FIG. 2, and system 300 of FIG. 3 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In a particular example, environment 100 may include additional information handling systems and service providers. In the discussion of the figures, reference may also be made to components illustrated in other figures for continuity of the description. In addition, the operations described herein as being performed by operating system 115, software application 120, and BMC 165 may be performed or executed by CPU 160 and/or processing subsystem 130.

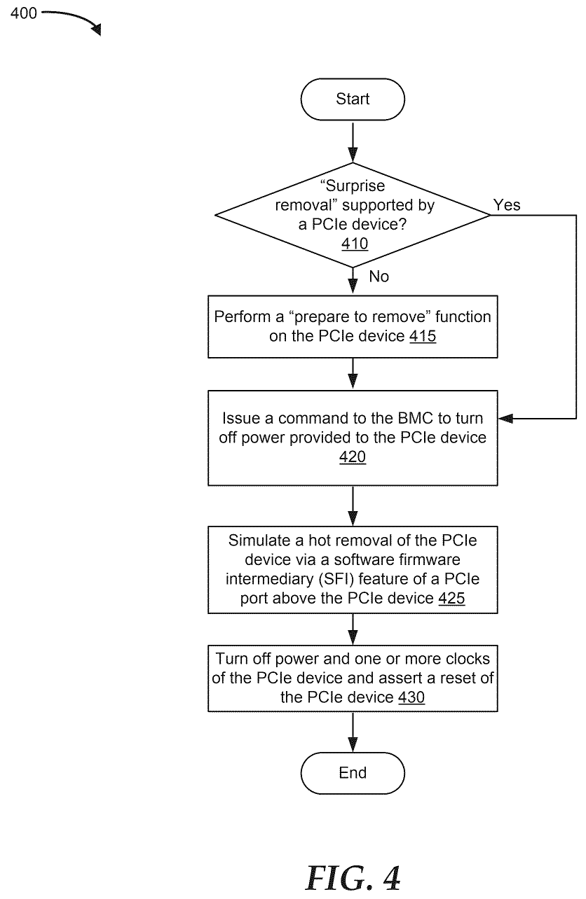

FIG. 4 illustrates a portion of a flowchart of a method 400 for SFI for runtime PCIe power management, according to an embodiment of the present disclosure. Method 400 may be configured to control power to one or more PCIe devices of an information handling system. Method 400 may be performed by any suitable component of environment 100 of FIG. 1 including, but not limited to CPU 160, BMC 165, power management system 155, and service provider 185 of FIG. 1. While embodiments of the present disclosure are described in terms of the components of environment 100 of FIG. 1, it should be recognized that other components may be utilized to perform the described method. One of skill in the art will appreciate that this flowchart explains a typical example, which can be extended to applications or services in practice. Also, it will be readily appreciated that not every method step set forth in this flow diagram is always necessary and that certain steps of the methods may be combined, performed simultaneously, in a different order, or perhaps omitted, without varying from the scope of the disclosure.

Method 400 typically starts at decision block 410 where the workload scheduler may determine that it does not have a workload to run on a PCIe device for a specified time, wherein the time specified may exceed a threshold. The workload scheduler may then determine whether a “surprise removal” feature, also referred to as an “async removal,” is supported by the PCIe device. If the surprise removal feature is supported by the PCIe device, then the “YES” branch is taken, and the method may proceed to block 420. If the surprise removal feature is not supported by the PCIe device, then the “NO” branch is taken, and the method may proceed to block 415.

At block 415, the workload scheduler may notify an operating system of the information handling system associated with the PCIe device to perform a “prepare to remove” operation on the PCIe device. For example, the “prepare to remove” operation may stop background activity and ongoing input/output (I/O) activity so that the PCIe device can be removed safely. The prepare to remove operation may also unbind a driver of the PCIe device from the operating system. At block 420, the workload scheduler may issue a command to direct the BMC to turn off power to the PCIe device because the workload scheduler will not be using the PCIe device.

At block 425, prior to turning off the power to the PCIe device, the BMC may utilize an SFI feature of a PCIe port above the PCIe device to simulate the hot removal of the PCIe device, wherein the PCIe port may be a PCIe root port or PCIe switch downstream port. This may hide or mask the PCIe device from the host software and/or workload scheduler. For example, the BMC may simulate or spoof a hot-plug event that the PCIe device was removed while the PCIe device is live and running. In a particular example, the BMC can simulate the hot removal by masking the physical presence indicator and active state of a PCIe link associated with the PCIe device. This may generate an interrupt that notifies the operating system that the PCIe device was removed. The BMC may also block access to the PCIe device and block readiness notifications from the PCIe device by updating one or more SFI control registers of a PCIe port above the PCIe device. For example, the BMC may update a field “Downstream Port Filtering” of the PCIe SFI feature of the PCIe port to block access to the PCIe device.

At this point, if the driver of the PCIe device is still bound to the operating system, the interrupt may also unbind the driver of the PCIe device from the operating system. The driver of the PCIe device may still be bound to the operating system at this point if the “prepare to remove” operation is not performed. Accordingly, the operating system and/or host software may stop utilizing and/or driving data to the PCIe device. The method may proceed to block 430 where the BMC may power off the PCIe device. The BMC may also turn off one or more clocks of the PCIe device. In addition, the BMC may also assert a reset of the PCIe device by sending a signal to a PCIe slot where the PCIe device is inserted. In one embodiment, the masking of the physical presence indicator and the active state of the PCIe link along with blocking access to the PCIe device and blocking readiness notifications from the PCIe device may be performed in parallel. Afterwards, the method ends.

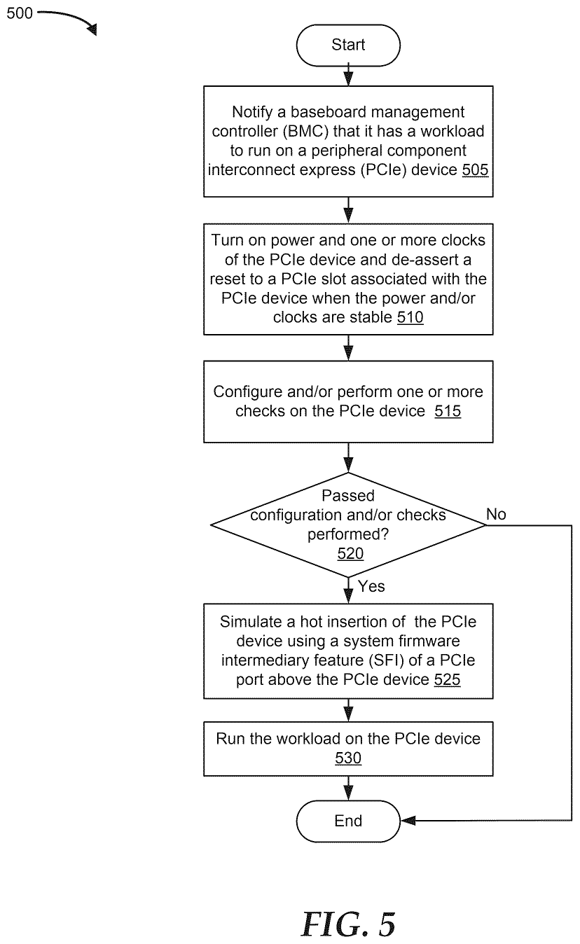

FIG. 5 illustrates a portion of a flowchart of a method 500 for SFI for runtime PCIe power management, according to an embodiment of the present disclosure. Method 500 may be configured to control power to one or more specific PCIe devices of an information handling system. Method 500 may be performed subsequent to a simulated hot removal of a PCIe device, such as in method 400 of FIG. 4, wherein power to the PCIe device has been removed. Method 500 may be performed by any suitable component of environment 100 of FIG. 1 including, but not limited to CPU 160, BMC 165, power management system 155, and service provider 185 of FIG. 1. While embodiments of the present disclosure are described in terms of the components of environment 100 of FIG. 1, it should be recognized that other components may be utilized to perform the described method. One of skill in the art will appreciate that this flowchart explains a typical example, which can be extended to applications or services in practice. Also, it will be readily appreciated that not every method step set forth in this flow diagram is always necessary and that certain steps of the methods may be combined, performed simultaneously, in a different order, or perhaps omitted, without varying from the scope of the disclosure.

Method 500 typically starts at block 505 where a workload scheduler may notify a BMC that it has a workload to run on a PCIe device. The workload scheduler may be configured to automatically signal or transmit a command/request to the BMC regarding the usage of one or more PCIe devices. The method may proceed to block 510 where the BMC may turn on power to the PCIe device. The BMC may also turn on one or more clocks of the PCIe device. In addition, the BMC may de-assert a reset to a PCIe slot associated with the PCIe device when the power and/or the clock(s) are stable. For example, BMC 165 may direct power controller 315 to generate and apply power and clock signals to PCIe device 140 via integrated circuit 320 of FIG. 3. In another example, BMC 165 may direct power controller 315 to de-assert a reset to the PCIe slot associated with PCIe device 140 via integrated circuit 320 of FIG. 3.

The method may proceed to block 515 where the BMC may configure the PCIe device. In addition, the BMC may perform one or more checks on the PCIe device. For example, the BMC may configure the PCIe device by changing values provided in PCIe configuration space registers. The configuration space registers include fields that identify the PCIe device and allow the device to be controlled. In addition, the BMC may also authenticate the PCIe device, such as via a security protocol and data model (SPDM) specification as one of the checks performed. This process may also be based on a policy provided by an administrator or manufacturer of the information handling system.

The method may proceed to block decision 520 where the BMC may determine whether the PCIe device passed the configuration and the one or more checks performed. If the PCIe device passes the configuration and one or more checks, then the “YES” branch is taken, and the method may proceed to block 525. If the PCIe device does not pass the configuration and one or more checks, then the “NO” branch is taken, and the method may end.

At block 525, the BMC may simulate a hot insertion of the PCIe device using the SFI feature of a PCIe port above the PCIe device. For example, the BMC may use PCIe SFI feature 240 for PCIe device 260 of FIG. 2. In another example, the BMC may use PCIe SFI feature 225 for PCIe device 140 of FIG. 2. In particular, the BMC may unmask the physical presence indicator and active state of a PCIe link associated with the PCIe device via the PCIe SFI feature of the PCIe device. This may generate an interrupt that notifies the operating system that the PCIe device was inserted, which may bind a driver of the PCIe device to the operating system. The BMC may also set a control bit of the SFI feature of the PCIe port above the PCIe device which may transmit a new readiness notification to the operating system, host software, and/or workload scheduler. The readiness notification may be used to indicate that the PCIe device is ready to be accessed. In addition, the BMC may unblock access of the operating system to the PCIe device. For example, the BMC may update a field “Downstream Port Filtering” of the PCIe SFI feature of the PCIe port above the PCIe device to unblock access to the PCIe device. This may allow the host software, operating system, and/or workload scheduler access to the PCIe device. Accordingly, the operating system, host software, and/or workload schedule may now utilize and/or drive data to the PCIe device, such as by running the workload on the PCIe device at block 530. In one embodiment, the unmasking of the physical presence indicator and the active state of the PCIe link along with transmitting the new readiness operation and unblocking access to the PCIe device may be performed in parallel. Afterward, the method ends.

FIG. 6 illustrates an embodiment of an information handling system 600 including processors 602 and 604, a chipset 610, a memory 620, a graphics adapter 630 connected to a video display 634, a non-volatile RAM (NVRAM) 640 that includes a basic input and output system/extensible firmware interface (BIOS/EFI) module 642, a disk controller 650, a hard disk drive (HDD) 654, an optical disk drive 656, a disk emulator 660 connected to a solid-state drive (SSD) 664, an input/output (I/O) interface 670 connected to an add-on resource 674 and a trusted platform module (TPM) 676, a network interface 680, and a baseboard management controller (BMC) 690. Processor 602 is connected to chipset 610 via processor interface 606, and processor 604 is connected to the chipset via processor interface 608. In a particular embodiment, processors 602 and 604 are connected together via a high-capacity coherent fabric, such as a HyperTransport link, a QuickPath Interconnect, or the like. Chipset 610 represents an integrated circuit or group of integrated circuits that manage the data flow between processors 602 and 604 and the other elements of information handling system 600. In a particular embodiment, chipset 610 represents a pair of integrated circuits, such as a northbridge component and a southbridge component. In another embodiment, some or all of the functions and features of chipset 610 are integrated with one or more of processors 602 and 604.

Memory 620 is connected to chipset 610 via a memory interface 622. An example of memory interface 622 includes a Double Data Rate (DDR) memory channel and memory 620 represents one or more DDR Dual In-Line Memory Modules (DIMMs). In a particular embodiment, memory interface 622 represents two or more DDR channels. In another embodiment, one or more of processors 602 and 604 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 620 may further represent various combinations of memory types, such as DRAM DIMMs, SRAM DIMMs, non-volatile DIMMs (NV-DIMMs), storage class memory devices, Read-Only Memory (ROM) devices, or the like. Graphics adapter 630 is connected to chipset 610 via a graphics interface 632 and provides a video display output 636 to a video display 634. An example of a graphics interface 632 includes a Peripheral Component Interconnect-Express (PCIe) interface and graphics adapter 630 can include a four-lane (x4) PCIe adapter, an eight-lane (x8) PCIe adapter, a 16-lane (x16) PCIe adapter, or another configuration, as needed or desired. In a particular embodiment, graphics adapter 630 is provided down on a system printed circuit board (PCB). Video display output 636 can include a Digital Video Interface (DVI), a High-Definition Multimedia Interface (HDMI), a DisplayPort interface, or the like, and video display 634 can include a monitor, a smart television, an embedded display such as a laptop computer display, or the like.

NVRAM 640, disk controller 650, and I/O interface 670 are connected to chipset 610 via an I/O channel 612. An example of I/O channel 612 includes one or more point-to-point PCIe links between chipset 610 and each of NVRAM 640, disk controller 650, and I/O interface 670. Chipset 610 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 640 includes BIOS/EFI module 642 that stores machine-executable code (BIOS/EFI code) that operates to detect the resources of information handling system 600, to provide drivers for the resources, to initialize the resources, and to provide common access mechanisms for the resources. The functions and features of BIOS/EFI module 642 will be further described below.

Disk controller 650 includes a disk interface 652 that connects the disc controller to a hard disk drive (HDD) 654, to an optical disk drive (ODD) 656, and to disk emulator 660. An example of disk interface 652 includes an Integrated Drive Electronics (IDE) interface, an Advanced Technology Attachment (ATA) such as a parallel ATA (PATA) interface or a SATA interface, a SCSI interface, a USB interface, a proprietary interface, or a combination thereof. Disk emulator 660 permits SSD 664 to be connected to information handling system 600 via an external interface 662. An example of external interface 662 includes a USB interface, an institute of electrical and electronics engineers (IEEE) 1394 (Firewire) interface, a proprietary interface, or a combination thereof. Alternatively, SSD 664 can be disposed within information handling system 600.

I/O interface 670 includes a peripheral interface 672 that connects the I/O interface to add-on resource 674, to TPM 676, and to network interface 680. Peripheral interface 672 can be the same type of interface as I/O channel 612 or can be a different type of interface. As such, I/O interface 670 extends the capacity of I/O channel 612 when peripheral interface 672 and the I/O channel are of the same type, and the I/O interface translates information from a format suitable to the I/O channel to a format suitable to the peripheral interface 672 when they are of a different type. Add-on resource 674 can include a data storage system, an additional graphics interface, a network interface card (NIC), a sound/video processing card, another add-on resource, or a combination thereof. Add-on resource 674 can be on a main circuit board, on separate circuit board, or add-in card disposed within information handling system 600, a device that is external to the information handling system, or a combination thereof.

Network interface 680 represents a network communication device disposed within information handling system 600, on a main circuit board of the information handling system, integrated onto another component such as chipset 610, in another suitable location, or a combination thereof. Network interface 680 includes a network channel 682 that provides an interface to devices that are external to information handling system 600. In a particular embodiment, network channel 682 is of a different type than peripheral interface 672 and network interface 680 translates information from a format suitable to the peripheral channel to a format suitable to external devices.

In a particular embodiment, network interface 680 includes a NIC or host bus adapter (HBA), and an example of network channel 682 includes an InfiniBand channel, a Fibre Channel, a Gigabit Ethernet channel, a proprietary channel architecture, or a combination thereof. In another embodiment, network interface 680 includes a wireless communication interface, and network channel 682 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 682 can be connected to an external network resource (not illustrated). The network resource can include another information handling system, a data storage system, another network, a grid management system, another suitable resource, or a combination thereof.

BMC 690 is connected to multiple elements of information handling system 600 via one or more management interface 692 to provide out-of-band monitoring, maintenance, and control of the elements of the information handling system. As such, BMC 690 represents a processing device different from processor 602 and processor 604, which provides various management functions for information handling system 600. For example, BMC 690 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 690 can vary considerably based on the type of information handling system. BMC 690 can operate in accordance with an Intelligent Platform Management Interface (IPMI). Examples of BMC 690 include an Integrated Dell® Remote Access Controller (iDRAC).

Management interface 692 represents one or more out-of-band communication interfaces between BMC 690 and the elements of information handling system 600 and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 600, that is apart from the execution of code by processors 602 and 604 and procedures that are implemented on the information handling system in response to the executed code.

BMC 690 operates to monitor and maintain system firmware, such as code stored in BIOS/EFI module 642, option ROMs for graphics adapter 630, disk controller 650, add-on resource 674, network interface 680, or other elements of information handling system 600, as needed or desired. In particular, BMC 690 includes a network interface 694 that can be connected to a remote management system to receive firmware updates, as needed or desired. Here, BMC 690 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 690 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 690, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 690 is included on a main circuit board (such as a baseboard, a motherboard, or any combination thereof) of information handling system 600 or is integrated into another element of the information handling system such as chipset 610, or another suitable element, as needed or desired. As such, BMC 690 can be part of an integrated circuit or a chipset within information handling system 600. An example of BMC 690 includes an iDRAC, or the like. BMC 690 may operate on a separate power plane from other resources in information handling system 600. Thus, BMC 690 can communicate with the management system via network interface 694 while the resources of information handling system 600 are powered off. Here, information can be sent from the management system to BMC 690 and the information can be stored in a RAM or NVRAM associated with the BMC. Information stored in the RAM may be lost after power-down of the power plane for BMC 690, while information stored in the NVRAM may be saved through a power-down/power-up cycle of the power plane for the BMC.

Information handling system 600 can include additional components and additional busses, not shown for clarity. For example, information handling system 600 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 600 can include multiple central processing units (CPUs) and redundant bus controllers. One or more components can be integrated together. Information handling system 600 can include additional buses and bus protocols, for example, I²C and the like. Additional components of information handling system 600 can include one or more storage devices that can store machine-executable code, one or more communications ports for communicating with external devices, and various input and output (I/O) devices, such as a keyboard, a mouse, and a video display.

For purposes of this disclosure, information handling system 600 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 600 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 600 can include processing resources for executing machine-executable code, such as processor 602, a programmable logic array (PLA), an embedded device such as a System-on-a-Chip (SoC), or other control logic hardware. Information handling system 600 can also include one or more computer-readable media for storing machine-executable code, such as software or data.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device. Also, it is to be appreciated that the term “user” in this context and elsewhere herein is intended to be broadly construed to encompass, for example, human, hardware, software, or firmware entities, as well as various combinations of such entities.

Although FIG. 4 and FIG. 5 show example blocks of method 400 and method 500 in some implementations, method 400 and method 500 may include additional blocks, fewer blocks, different blocks, or differently arranged blocks than those depicted in FIG. 4 and FIG. 5. Those skilled in the art will understand that the principles presented herein may be implemented in any suitably arranged processing system. Additionally, or alternatively, two or more of the blocks of method 400 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), an FPGA, a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
in response to receiving a notification, by a processor in an information handling system, to power off a peripheral component interconnect express (PCIe) device of the information handling system, simulating a hot removal of the PCIe device by utilizing a system firmware intermediary feature of a PCIe port above the PCIe device; and
turning off power provided to the PCIe device.

2. The method of claim 1, further comprising masking a link active state associated with the PCIe device.

3. The method of claim 1, further comprising masking a readiness notification associated with the PCIe device.

4. The method of claim 1, further comprising masking a physical presence indicator associated with the PCIe device.

5. The method of claim 1, further comprising turning off a clock of the PCIe device.

6. The method of claim 1, further comprising asserting a reset to a PCIe slot associated with the PCIe device.

7. The method of claim 1, further comprising blocking access to the PCIe device by updating a field in the system firmware intermediary feature of the PCIe port.

8. An information handling system, comprising:
a processor; and
a memory coupled to the processor, the memory having program instructions stored thereon that upon execution cause the processor to:
in response to receiving a notification that a peripheral component interconnect express (PCIe) device of the information handling system will be utilized to run a workload, providing power to the PCIe device and configuring the PCIe device;
simulating a hot insertion of the PCIe device by utilizing a system firmware intermediary feature of a PCIe port above the PCIe device; and
running the workload subsequent to the simulating the hot insertion of the PCIe device.

9. The information handling system of claim 8, wherein the execution of the program instructions further causes the processor to de-assert a reset to a PCIe slot associated with the PCIe device.

10. The information handling system of claim 8, wherein the execution of the program instructions further causes the processor to turn on a clock in the PCIe device.

11. The information handling system of claim 8, wherein the execution of the program instructions further causes the processor to allow access to the PCIe device.

12. The information handling system of claim 8, wherein the execution of the program instructions further causes the processor to run the workload on the PCIe device subsequent to the hot insertion of the PCIe device.

13. The information handling system of claim 8, wherein the execution of the program instructions further causes the processor to transmit a readiness notification.

14. A non-transitory computer-readable medium to store instructions that are executable to perform operations comprising:
in response to receiving a notification to power off a peripheral component interconnect express (PCIe) device of an information handling system, simulating a hot removal of the PCIe device by utilizing a system firmware intermediary feature of a PCIe port above the PCIe device; and
turning off power provided to the PCIe device.

15. The non-transitory computer-readable medium of claim 14, wherein the operations further comprise masking a link active state associated with the PCIe device.

16. The non-transitory computer-readable medium of claim 14, wherein the operations further comprise masking a readiness notification associated with the PCIe device.

17. The non-transitory computer-readable medium of claim 14, wherein the operations further comprise masking a physical presence indicator associated with the PCIe device.

18. The non-transitory computer-readable medium of claim 14, wherein the operations further comprise turning off a clock of the PCIe device.

19. The non-transitory computer-readable medium of claim 14, wherein the operations further comprise asserting a reset to a PCIe slot associated with the PCIe device.

20. The non-transitory computer-readable medium of claim 14, wherein the operations further comprise blocking access to the PCIe device by updating a field in the system firmware intermediary feature of the PCIe port.
